(19) United States
(12) Patent Application Publication
(10) Pub. No.: US 2008/0117096 A1
(43) Pub. Date: May 22, 2008

(54) Device for Distance Measurement with the Aid of Electromagnetic Waves

(76) Inventors: Matthias Eckel, Markgroeningen (DE); Juergen Hoetzel, Florstadt (DE)

Correspondence Address: KENYON & KENYON LLP, ONE BROADWAY, NEW YORK, NY, 10004, US

(21) Appl. No.: 11/667,900

(22) PCT Filed: Sep. 16, 2005
(86) PCT No.: PCT/EP05/54616

§ 371 Date: Oct. 2, 2007

(30) Foreign Application Priority Data
Nov. 15, 2004 (DE) 10 2004 055 063.8

(51) Int. Cl. G01S 13/10

(52) U.S. Cl. 342/134

(57) ABSTRACT

A device for distance measurement with the aid of electromagnetic waves includes a transmitting device for transmitting, in a measuring mode, electromagnetic waves as a transmitted signal to a measured object, a receiving device for receiving, in the measuring mode, the electromagnetic waves back-scattered by the measured object as a received signal, and an analyzer device for determining, in an analysis mode, the propagation time, and for outputting a measured distance, the analyzer device having a compensation unit for compensating distance measurements carried out during the analysis mode.

### FIELD OF THE INVENTION

The present invention relates to distance measuring devices in general and, in particular, it relates to a device for distance measurement with the aid of electromagnetic waves.

Although example embodiments of the present invention are utilizable for any type of distance measurements, example embodiments of the present invention are described below with reference to a warning device and a warning method for a motor vehicle.

In particular, example embodiments of the present invention relate to a distance measuring device which uses electromagnetic waves and includes: a transmitting device for transmitting, in a measuring mode, electromagnetic waves as a transmitted signal to a measured object, the transmitting device also having a pulse generator for outputting a pulse control signal such that the electromagnetic waves are output as transmitted pulses as a function of an activation by a pulse generator; a receiving device for receiving, in the measuring mode, the electromagnetic waves back-scattered by the measured object as a received signal, the receiving device also having a delay unit for delaying in time the pulse control signal output by the pulse generator as a function of a ramp signal supplied to the delay unit and for outputting a delayed pulse control signal, and a mixing unit for mixing the received signal with transmitted pulses, time-delayed according to the delayed pulse control signal, and for outputting a measuring signal as a function of the measured distance, the measuring signal being output only if the time delay defined by the delay unit coincides with a propagation time of the transmitted pulses from the transmitting device to the measured object and back to the receiving device; and an analyzer device for determining, in an analysis mode, the propagation time, and for outputting the measured distance as a measurement result.

### BACKGROUND INFORMATION

In general, distance measuring systems which perform distance measurements on the basis of electromagnetic waves back-scattered by a measured object are used for distance measurement in motor vehicles. Electromagnetic waves having a base frequency of 24 gigahertz (GHz), for example, are transmitted as individual pulses to the measured object, i.e., an obstacle located in front of the vehicle, and reflected back by this object. The transmitted pulses reflected back by the measured object are detected in a receiving device of the measuring system where they are superimposed with the originally transmitted pulses, which are used as reference pulses. A mixing device and an analyzer circuit are responsible for a measuring signal being output from a mixing unit in which the reference pulse is mixed with the received transmitted pulses only if the reference pulses coincide in time with the corresponding transmitted pulses back-scattered by the measured object. Since the transmitted pulses back-scattered by the measured object require a propagation time from the transmitting device to the measured object and back to the receiving device of the measuring system, in order to achieve a time overlap, the received pulses in the receiving device of the measuring system are also time delayed by a delay unit. Normally a time delay is specified in the form of a ramp signal (voltage ramp) as FIG. 4 shows for a conventional measuring system. In the graph of FIG. 4, the x axis corresponds to a signal variation over time, while the y axis denotes the signal delay of the transmitted pulses with respect to the reference pulses and is calibrated in distance values (25 cm . . . 2.5 m). If there is an obstacle in front of the transmitting device at a distance of 2.5 m, for example, the mixing unit situated in the receiving device outputs a measuring signal at a point in time corresponding to this measured distance as shown by the dashed line in FIG. 4. Furthermore, FIG. 4 shows that a measurement is performed repetitively, i.e., the voltage ramp and thus the continuous time delay which is set by the delay unit is repeated multiple times. Furthermore, FIG. 4 shows that a measuring pause between the individual voltage ramps is predefined in order to allow time for the analyzer unit of the measuring system (LF part) to analyze the pulses output by the mixing unit and to provide a measurement result.

FIG. 3 shows a typical curve of the ramp signal in the scan phase and the analysis phase (A), the measured distance (ME) being plotted as a function of time. In the case of the conventional measurement method, as analysis time A the voltage ramp signal remains at a constant value, usually at a value between a minimum voltage value and a maximum voltage value of the voltage ramp. This value indicated in FIG. 3 by Z corresponds to a specific distance which may be measured by the distance measuring system. Depending on the resolution of the measuring system, the distances associated with the voltage values of the voltage ramp are divided into “distance cells.” The distance cell corresponding to voltage value Z is thus measured during the analysis mode, since transmitted pulses are continuously transmitted to the measured object and are received from the measured object by the receiving device of the measuring system even during the analysis mode.

If a measured object is located in front of the sensor within such a distance cell, a meaningful signal is obtained, which charges coupling capacitors situated between the HF part of the measuring system and the LF part of the measuring system, displacing the working point in the LF part of the measuring system. In a subsequent scan (reference symbol N in FIG. 3) this disadvantageously results in a measuring error.

### SUMMARY

Example embodiments of the present invention provide a distance measuring device and a corresponding method in which a displacement of the working point which is caused by measurements performed during the analysis mode may be prevented.

Example embodiments of the present invention provide, with the aid of the ramp generator provided in the receiving device of the measuring system, such a ramp signal to make it possible to address different distance cells even during the analysis mode, resulting in different distance measuring signals which mutually compensate one another during the analysis time. In this manner, it may be achieved that a displacement of the working point in the LF part of the measuring device is prevented by such a compensation.

It is thus possible to retain coupling capacitors which are situated in the LF part, in order to implement a simple and cost-effective circuit arrangement. The coupling capacitors are charged during the measuring pause, i.e., during the analysis time, by distance measurements which are carried out in the individual distance cells; however, compensation is achieved by positive and negative chargings of the coupling capacitor canceling out one another due to the activation of different distance cells corresponding to different measured distances. In this manner, the state is achieved where no relevant distance measurement is performed during the analysis time, so that a measurement following a measurement pause may start in the LF part without the working point being displaced.

The measuring device according to example embodiments of the present invention for distance measurement with the aid of electromagnetic waves has: a transmitting device for transmitting, in a measuring mode, electromagnetic waves as a transmitted signal to a measured object, the transmitting device also having a pulse generator for outputting a pulse control signal such that the electromagnetic waves are output as transmitted pulses as a function of an activation by a pulse generator; a receiving device for receiving, in the measuring mode, the electromagnetic waves back-scattered by the measured object as a received signal, the receiving device also having a delay unit for delaying in time the pulse control signal output by the pulse generator as a function of a ramp signal supplied to the delay unit and for outputting a delayed pulse control signal; and a mixing unit for mixing the received signal with transmitted pulses, time-delayed according to the delayed pulse control signal, and for outputting a measuring signal as a function of the measured distance, the measuring signal being output only if the time delay defined by the delay unit coincides with a propagation time of the transmitted pulses from the transmitting device to the measured object and back to the receiving device; and an analyzer device for determining, in an analysis mode, the propagation time and for outputting the measured distance as a measurement result, a compensation unit being provided for compensating distance measurements carried out during the analysis mode.

The measurement result may be divided into different distance cells corresponding to the measured distance.

The compensation unit for compensating distance measurements carried out during the analysis mode may include a processing and control unit (a microcontroller, for example) for processing the measuring signal output as a function of the measured distance, and a ramp generator, using the ramp signal, the ramp generator activating the delay unit during the analysis mode such that at least two different distance cells are set.

The compensation unit may be arranged as a microcontroller, which predefines the ramp signal for the delay unit of the receiving device.

In the measuring mode for measuring the distances, the distances may be divided into a predefinable number (n) of distance cells. The distance measurement carried out by the distance measuring device may be based on the use of optical radiation.

Exemplary embodiments of the present invention are illustrated in the drawing and explained in greater detail in the description that follows.

### BRIEF DESCRIPTION OF THE DRAWING

FIG. 1 shows a block diagram of a measuring system having a transmitting device, a receiving device, and an analyzer device according to an exemplary embodiment of the present invention.

FIG. 2 shows the variation of a ramp signal during a measuring period according to an example embodiment of the present invention.

FIG. 3 shows the variation of a ramp signal in a conventional measuring method.

FIG. 4 shows a graph illustrating the generation of a measuring signal in a conventional measuring method.

### DETAILED DESCRIPTION

In the figures, the same reference symbols identify components or steps that are identical or have an identical function.

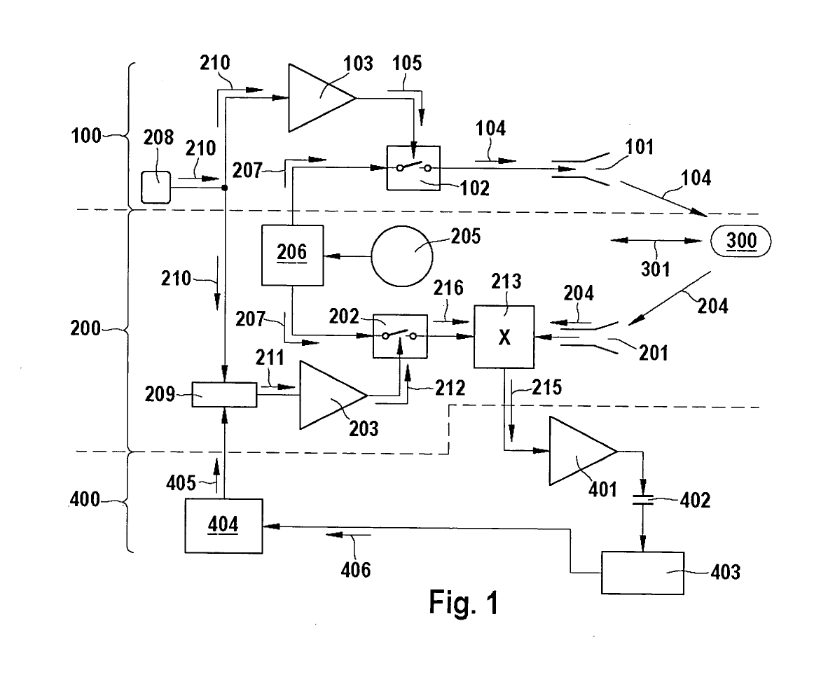

FIG. 1 shows a block diagram of a distance measuring system according to an exemplary embodiment of the present invention. As illustrated in FIG. 1, the measuring system is divided into a transmitting device 100, a receiving device 200, and an analyzer device 400. Normally, the block containing transmitting device 100 and receiving device 200 is referred to as the high-frequency part (HF part) of the circuit system, while analyzer device 400 forms the low-frequency part (LF part) of the analyzer device.

The electromagnetic waves used for the distance measurement are generated in an oscillator unit 205. The electromagnetic waves generated in oscillator unit 205 are supplied to transmitting device 100 as an oscillator output signal 207, as well as further processed in receiving device 200.

In the following, the operation of transmitting device 100 will be briefly described. A reference numeral 102 denotes a transmission switching unit, which is responsible for the possibility of transmitting the electromagnetic waves provided as oscillator output signal 207 in a pulsed, rather than continuous, manner. For this purpose, transmission switching unit 102 is activated by a transmitted pulse generating signal output by a transmission driver unit 103. A transmitted signal 104 having individual transmitted pulses is thus provided by transmission switching unit 102. The base frequency of the transmitted pulses, i.e., the oscillator frequency of oscillator unit 205, is typically 24 GHz. Such a frequency may be used for radar sensors.

Transmitting device 100 also has a pulse generator 208, which provides pulse control signals 210 for processing in transmitting device 100 and in receiving device 200. Pulse generator 208 delivers pulse control signal 210 for activating transmission driver unit 103, which switches oscillator output signal 207 through to a transmitting antenna 101 according to pulse control signal 210. Transmitted signal 104 is thus emitted to a measured object 300 as a pulse signal and reflected/scattered/refracted by the object. Transmitted signal 104 back-scattered by measured object 300 is received by receiving device 200 in the form of a received signal 204. The structure, i.e., base frequency and pulse modulation, of received signal 204 is exactly the same as that of transmitted signal 104 with the exception that the propagation time of the electromagnetic waves from transmitting antenna 101 of transmitting device 100 to measured object 300 and back to a receiving antenna 201 of receiving device 200 causes a time delay due to measured distance 301.

It should be pointed out that the measured distance, divided into different “distance cells” among other things, represents the desired measuring signal, which is to be obtained using the device for distance measurement. The propagation time difference between the point in time transmitted signal 104 is emitted from the transmitting antenna and the point in time the corresponding received signal 204 is received in receiving antenna 201 is approximately equal to twice the measured distance represented by reference numeral 301, divided by the speed of light (c).

In the following, the operation of receiving device 200 is briefly and schematically described with reference to the schematic block diagram of FIG. 1.

Receiving device 200 has a reception switching unit 202 which is designed similarly to transmission switching unit 102 of transmitting device 100, and is responsible for oscillator output signal 207 output by oscillator unit 205 being “chopped up” into individual pulses. A mixer input signal 216 is thus obtained, which, except for a time shift, corresponds to transmitted signal 104 of transmitting device 100. As described above, taking into account the explanation for transmitting device 100, reception switching unit 202 of receiving device 200 is also activated by an appropriate received pulse generation signal 212. Received pulse generation signal 212 is obtained from a reception driver unit 203, which is also activated via pulse generator 208 situated in transmitting device 100. The pulse generator thus delivers pulse control signals 210 having identical repeat frequency and period length to transmitting device 100 and to receiving device 200.

Receiving device 200 also has a delay unit 209, which makes it possible to time-delay pulse control signal 210 supplied to it in order to obtain a delayed pulse control signal 211. The time delay provided by delay unit 209 may be set using a ramp signal 405, which is described below.

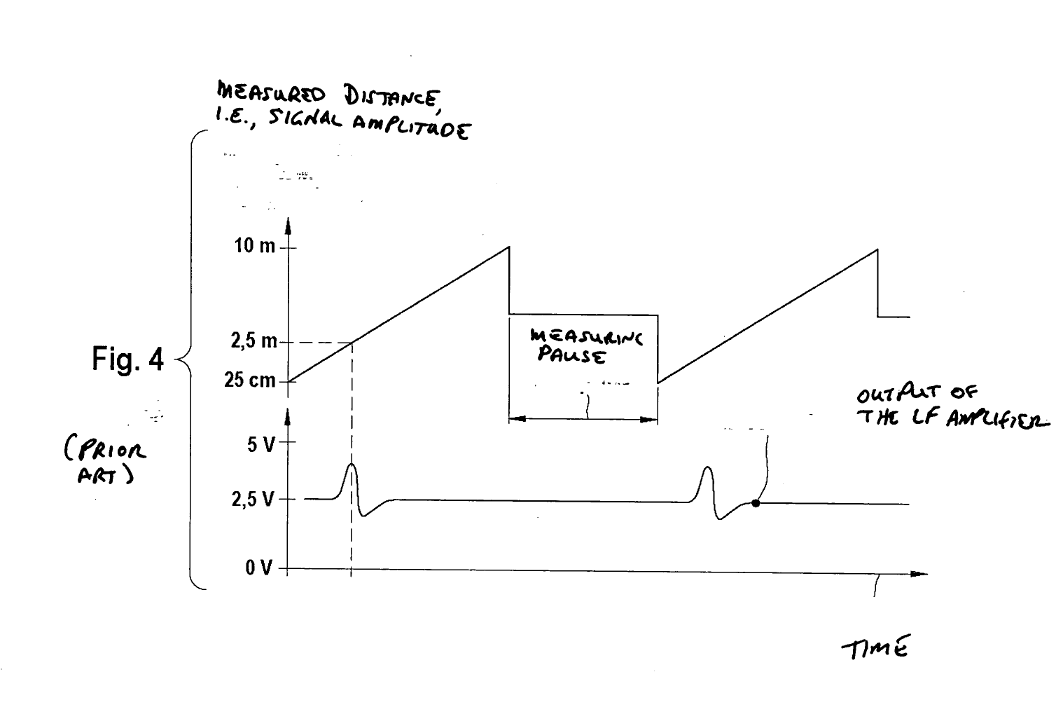

A reference numeral 213 denotes a mixing unit in which received signal 204 received from the measured object and the mixer input signal, which has the time delay provided by delay unit 209, may be mixed. Mixing unit 213 is configured such that it outputs a measuring signal 215 only if the pulses contained in received signal 204 correlate exactly in time with the pulses contained in mixer input signal 216. Such pulses have a curve such as was explained conventionally, with reference to FIG. 4, i.e., the output of an amplifier unit 401 (LF amplifier) corresponds to the lower curve shown in FIG. 4.

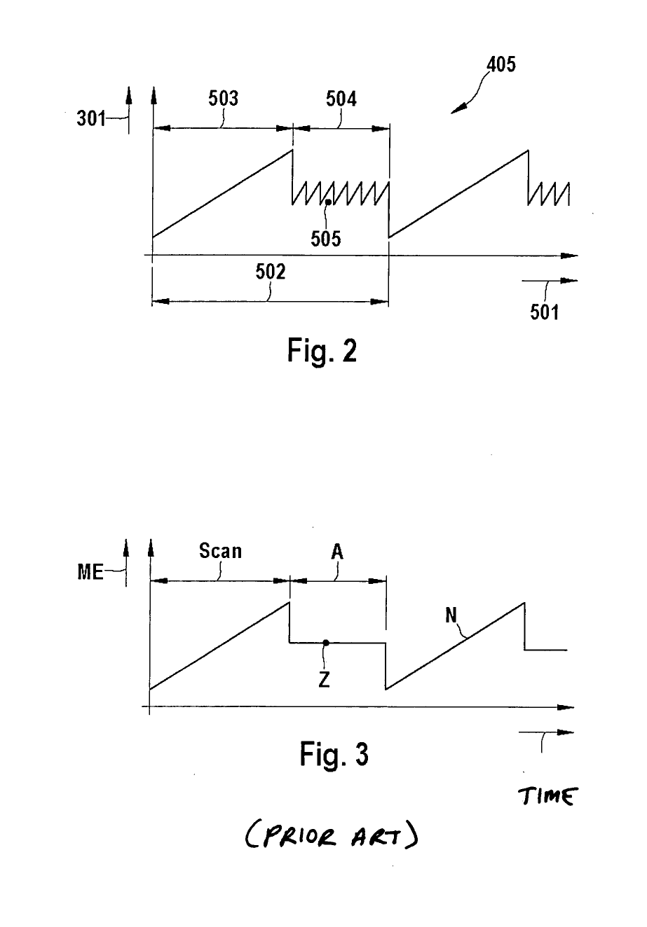

In the following, analyzer device 400 provided in the measuring system is briefly explained. Amplifier unit 401 in the analyzer device is used for amplifying the output signal of mixing unit 213, which represents measuring signal 215. As shown above with reference to the explanation for receiving device 200, the time of occurrence of measuring signal 215 corresponds to a measured distance 301. The measuring signal output from amplifier unit 401 (output of the LF amplifier, see FIG. 4) is supplied to a coupling capacitor 402, which must be present in the distance measuring systems for decoupling the HF part from the LF part. Coupling capacitor 402 is connected to a processing and control unit 403, in which measuring signal 215 is processed. Furthermore, processing and control unit 403, which may be configured as a microcontroller, outputs a control signal 406 to a ramp generator 404. Activating ramp generator 404 via control signal 406 causes a ramp signal 405 to be provided, which has a variation over time as described below with reference to FIG. 2.

In the following, ramp signal 405, which is output from ramp generator 404, is described first in detail with reference to FIG. 2. FIG. 2 shows the curve of a measured distance 301, which corresponds to a time delay of the transmitted pulses due to the transmission from transmitting antenna 101, reflection on measured object 300, and subsequent receipt by receiving antenna 201, plotted as a function of a time 501.

A reference numeral 502 in FIG. 2 corresponds to a measuring period, which is repeated multiple times, i.e., repetitive measurements are provided. The measuring period is divided into a sampling period 503 and a signal analysis period 504. As described above, the ramp-shaped signal during sampling period 503 results in a continuously increasing delay being provided by delay unit 209 to which ramp signal 405 is supplied. If the time delay set by the ramp during sampling period 503 and implemented by delay unit 209 corresponds to a specific measured distance 301, in which there is a measured object 300 in front of the distance measuring system, a measuring signal 215 is output from mixing unit 213, whereupon a corresponding distance may be calculated in processing device 403. Such a determination of the distance is performed during signal analysis period 504 shown in FIG. 2. According to example embodiments of the present invention, ramp generator 404 delivers, during signal analysis period 504, a compensation ramp signal 505 such that a predefinable number of ramps are run through, whereby different distance cells are settable. In this, manner coupling capacitor 402 receives different—positive and negative—voltage signals, which cancel out one another in the case of an appropriate number of set distance cells. The advantage according to example embodiments of the present invention is thus achieved in that the working point in the LF part of the distance measuring system is not displaced.

Normally the potential of the voltage ramp, i.e., of ramp signal 405 generated by ramp generator 404, is proportional to measured distance 301. It may be provided to configure ramp signal 405 as a stepped function where each individual step corresponds to a distance cell. All distance cells are first addressed by the LF part of the measuring system from the beginning to the end of the measurement, whereupon the useful signal is stored. In the subsequent signal analysis period 504 a signal analysis is then performed, whereupon the next scan, i.e., the following sampling period 503, begins. According to example embodiments of the present invention, different distance cells are constantly set even during signal analysis period 504, since during signal analysis period 504 ramp signal 405 is configured as a compensation ramp signal 505, as illustrated in FIG. 2.

Not a single distance cell thus remains set, as described above with reference to the conventional method, but always new distance cells are set such that coupling capacitor 402 of analyzer device 400 cannot be charged to any substantial extent. It is thus achieved that a displacement of the working point in the LF part before a new measuring cycle, i.e., a new sampling period 503, is prevented.

Normally, the flanks of pulse control signal 210 trigger the transmitted pulse generation, i.e., the generation of mixer input signal 216. The repeat frequency of pulse control signal 210 provided by pulse generator 208 is typically 2.5 megahertz (MHz). A range of 25 cm to 10 m may be settable for a measured distance 301, the distance cells having a geometric length of 4 cm. The travel which is provided by compensation ramp signal 505 during a signal analysis period 504 of measuring period 502 may correspond to a travel corresponding to a geometric length of 100 cm.

Regarding the conventional measuring method illustrated in FIGS. 3 and 4, reference is made to the preamble of the description.

Although example embodiments of the present invention have been described above on the basis of certain exemplary embodiments, it is not limited thereto, but may be modified in multiple manners.

Example embodiments of the present invention are also not limited to the above-mentioned application options in motor vehicles.

1-10. (canceled)

11. A device for distance measurement with electromagnetic waves, comprising:
a transmission device configured to transmit, in a measurement mode, electromagnetic waves as a transmitted signal to a measured object, the transmission device including a pulse generator configured to output a pulse control signal such that the electromagnetic waves are output as transmitted pulses as a function of an activation by the pulse generator;
a receiver device configured to receive, in the measurement mode, the electromagnetic waves back-scattered by the measured object as a received signal, the receiver device including:
a delay unit configured to delay in time the pulse control signal output by the pulse generator as a function of a ramp signal supplied to the delay unit and to output a delayed pulse control signal; and
a mixer unit configured to mix the received signal with transmitted pulses, time-delayed according to the delayed pulse control signal, and to output a measurement signal as a function of the measured distance, the measurement signal being output only if the time delay defined by the delay unit coincides with a propagation time of the transmitted pulses from the transmission device to the measured object and back to the receiver device; and
an analyzer device configured to determine, in an analysis mode, the propagation time and to output the measured distance as a measurement result, the analyzer device including a compensation unit configured to compensate distance measurements carried out during the analysis mode.

12. The device according to claim 11, wherein the measurement result is divided into different distance cells corresponding to the measured distance.

13. The device according to claim 12, wherein the compensation unit includes a processor and control unit configured to process the measuring signal output as a function of the measured distance, and a ramp generator, the ramp generator configured to activate the delay unit during the analysis mode using the ramp signal such that at least two different distance cells are set.

14. The device according to claim 11, wherein the compensation unit is arranged as a microcontroller, which predefines the ramp signal for the delay unit of the receiver device.

15. The device according to claim 12, wherein the distances to be measured in the measurement mode are divided into a predefinable number of distance cells.

16. The device according to claim 12, wherein the compensation unit is configured to set a plurality of different distance cells.

17. The device according to claim 11, wherein optical radiation is provided with the aid of electromagnetic waves for distance measurement.

18. A method for distance measurement with electromagnetic waves, comprising:
transmitting, using a transmitting device, in a measuring mode, electromagnetic waves as a transmitted signal to a measured object, the transmitting device including a pulse generator for outputting a pulse control signal such that the electromagnetic waves are output as transmitted pulses as a function of an activation by a pulse generator;
receiving, with the aid of a receiving device, in the measuring mode, the electromagnetic waves back-scattered by the measured object as a received signal, the receiving device including:
a delay unit for delaying in time the pulse control signal output by the pulse generator as a function of a ramp signal supplied to the delay unit and for outputting a delayed pulse control signal; and
a mixing unit for mixing the received signal with transmitted pulses, time-delayed according to the delayed pulse control signal, and for outputting a measuring signal as a function of the measured distance, the measuring signal being output only if the time delay defined by the delay unit coincides with a propagation time of the transmitted pulses from the transmitting device to the measured object and back to the receiving device; and
determining, with the aid of an analyzer device, in an analysis mode, the propagation time, and outputting the measured distance as a measurement result;
wherein distance measurements carried out during the analysis mode are compensated with the aid of a compensation unit.

19. The method according to claim 18, wherein the delay unit is activated by a ramp generator during the analysis mode using the ramp signal such that at least two different distance cells are set.

20. The method according to claim 19, wherein the compensation unit for compensating distance measurements carried out during the analysis mode sets a plurality of different distance cells.
